(19) United States
(12) Patent Application Publication
(10) Pub. No.: US 2008/0277346 A1
(43) Pub. Date: Nov. 13, 2008

(54) Process for preparing substrates with porous surface

(75) Inventors: Joseph J. Kirkland, Wilmington, DE (US); Timothy J. Langlois, Wilmington, DE (US)

Correspondence Address: HOFFMANN & BARON, LLP, 6900 JERICHO TURNPIKE, SYOSSET, NY, 11791, US

(73) Assignee: Advanced Materials Technology, Inc.

(21) Appl. No.: 11/705,620

(22) Filed: Feb. 13, 2007

Related U.S. Application Data
(60) Provisional application No. 60/772,634, filed on Feb. 13, 2006.

(51) Int. Cl. B01D 15/08; B05D 1/36; B32B 15/02

(52) U.S. Cl. 210/656; 427/202; 428/402.24

(57) ABSTRACT

A process for preparing nanoparticle coated surfaces including the steps of electrostatically coating surfaces with polyelectrolyte by exposing the surface to a solution or suspension of polyelectrolyte, removing excess non-bound polyelectrolyte, then further coating the particles with a multi-layer of charged nanoparticles by exposing the polyelectrolyte-coated surface to a fluid dispersion including the charged nanoparticles. The process steps can optionally be repeated thereby adding further layers of polyelectrolyte followed by nanoparticles as many times as desired to produce a second and subsequent layers. The polyelectrolyte has an opposite surface charge to the charged nanoparticles and a molecular weight at the ionic strength of the fluid that is effective so that the first, second, and subsequent layers independently comprise a multiplicity of nanoparticle layers that are thicker than monolayers.

### CROSS-REFERENCE TO RELATED APPLICATIONS

The present application claims the benefit of U.S. Provisional Application No. 60/772,634, filed Feb. 13, 2006, the contents of which are incorporated herein by reference.

### FIELD OF THE INVENTION

The present invention relates to compositions and methods for coating surfaces with multilayers of nanoparticles. The present invention also relates to compositions and methods for conducting high efficiency liquid chromatographic separations and more specifically, to novel compositions and production methods for packing material used in chromatography columns.

### BACKGROUND OF THE INVENTION

Surfaces with porous coatings have many practical applications, such as chemical or biochemical reactors, catalysts, chromatography packing materials, and the like. Liquid chromatography is discussed herein as a specific illustration of the present invention, however, the invention is not limited to chromatography uses.

Separations using high performance liquid chromatography (HPLC) rely on the fact that a number of component solute molecules in a flowing stream of a fluid percolate through a packed bed of particles having a sorptive stationary phase. This process allows different solute molecules to be efficiently separated from one another. Each component has a different affinity for the stationary phase, leading to a different rate of migration and exit time for each component from the column. The separation efficiency is determined by the amount of spreading of the solute bands as they traverse the column.

The chromatographic apparatus generally employed for separating mixtures of solutes are columns. These columns are open tubes which typically have been packed with a granular material. For analytical work, the columns are usually of small internal diameter in the 1 to 10 millimeter range. They are of larger diameter for preparative chromatography. Commonly employed support materials are granules having active surfaces or surfaces which have been coated with a substance which is active. Passing the mixture to be separated through the column results in repeated interactions associated with the chemical nature of the different components and the chromatographically-active surfaces. Different compounds will have different retention times on the column due to these repeated interactions. The column eluent is generally passed through an analyzer, for example an ultraviolet absorption detector, to determine when the resolved components emerge from the column and to permit the measurement of the retention times and amounts of each component.

It has long been recognized that ideal chromatographic supports would consist of a plurality of discrete particles of perfectly regular shape, preferably spheres, comprised of uniform, interconnecting pores and no deep micropores. For different columns to give reproducible chromatographic results, the support granules should be regular in particle size and their surface characteristics readily controllable and reproducible.

For instance, British Patent No. 1,016,635 discloses a chromatographic support made by coating a particulate refractory solid on an impermeable core. The particulate coating is accomplished by dispersing the coating material in a suitable liquid in a slurry. The cores are then coated with the slurry, withdrawn and dried to remove the liquid. The result is a rather loosely held, mechanical coating of non-uniform disoriented particles. These coated cores may be used as chromatographic supports although they suffer from several disadvantages. The coatings are subject to easy removal as by chipping and flaking. Such variables as thickness and uniformity of coating cannot be controlled since, due to surface tension, the coating is thicker at the points of contact between the cores than elsewhere. It would be desirable to have the coated material irreversibly bound to the core and ideally the binding process would be such that the coating would be uniform, of predictable thickness, and of predeterminable porosity.

Kirkland, in Kirkland, J. J., “Gas Chromatography 1964,” The Institute of Petroleum, London, W. 1, 285-300 (1965), has described the preparation of a chromatographic support by binding successive layers of silica microparticles to glass beads by means of very thin fibrillar boehmite films. These coated cores may be employed as chromatographic adsorbents or supports, but suffer from the serious disadvantage of having a chemically inhomogeneous surface. The small but significant amounts of high surface area alumina which is present in the porous layer is deleterious for certain types of separations due to the adsorption or reacting properties of the alumina.

Coated glass beads consisting of a single layer of finely divided diatomaceous earth particles bound to the glass beads with fibrillar boehmite have also been described as a chromatographic support (Kirkland, J. J., “Gas Chromatography 1964,” The Institute of Petroleum, London, W. 1, 285-300 (1965); Kirkland, J. J., Anal. Chem. 37, 1458-1461, (1965)). The disadvantage of this material as a chromatographic support is that the surface again is not chemically homogeneous. In addition, it is not possible to prepare such structures with a uniform surface and with a certain predetermined porosity.

A method of depositing colloidal particles of a given size and ionic charge from aqueous dispersion onto the surface of a solid, a single monolayer of particles at a time, and by repeating the process to coat the surface with any desired number of monolayers, is described in U.S. Pat. No. 3,485,658 to Iler, incorporated herein in its entirety by reference.

A process for laying down one monolayer of particles at a time onto a core particle is also described in U.S. Pat. No. 3,505,785 to Kirkland, incorporated herein in its entirety by reference. U.S. Pat. No. 3,505,785 shows how colloidal particles can be attached to a core by using layers of “organic colloid”. A coating of monolayers of colloidal inorganic particles in which all of the particles are alike, is produced by first forming a coating consisting of alternate layers of colloidal inorganic particles and of an organic colloid, usually a polymeric material, and then removing the alternate monolayers of organic matter so as to obtain a residual coating of layers of colloidal inorganic particles in which all the microparticles are alike.

U.S. Pat. No. 3,505,785 further explains and claims that the monolayers put down by the process are of a thickness of one particle.

U.S. Pat. No. 6,479,146 to Caruso et al., which is incorporated herein in its entirety by reference, describes fabrication of layer-coated particles and hollow shells via electrostatic self-assembly of nanocomposite layers on decomposable colloidal templates in a process that is very similar to that of U.S. Pat. No. 3,505,785, referred to above.

According to U.S. Pat. No. 6,479,146, a coating of monolayers of colloidal inorganic microparticles in which all of the nanoparticles are alike, is produced by first forming a coating consisting of alternate monolayers of colloidal inorganic nanoparticles and of an organic colloid, and then removing the alternate monolayers of organic matter so as to obtain a residual coating of layers of colloidal inorganic particles in which all the nanoparticles are alike.

The laying down of one layer at a time of one particle thickness is detrimental to manufacturing efficiency as the coating process must be repeated by as many times as is necessary to build up a chromatographically functioning porous layer of particles. The present inventors have devised a method for laying down multiparticle layers that overcomes this shortcoming of the prior art processes.

### SUMMARY OF THE INVENTION

In some embodiments of the present invention, there is provided a process for preparing a coated surface including the steps of:

(a) providing a surface to be coated in a fluid;

(b) treating the surface with polyelectrolyte by exposing the surface to a solution or suspension of polyelectrolyte to form a first treated surface;

(c) removing excess non-bound polyelectrolyte without drying the first treated surface;

(d) further treating the first treated surface by attaching a first multilayer including a plurality of charged nanoparticles that are opposite in charge to the polyelectrolyte by exposing the product from step (c) to a suspension containing the charged nanoparticles;

(e) removing excess non-bound charged nanoparticles;

(f) optionally repeating steps (b), (c), (d) and (e) by adding further layers of polyelectrolyte followed by multilayers of charged nanoparticles as many times as desired to produce a second and subsequent multilayers of charged nanoparticles on the surface;

(g) optionally removing the organic layers by volatilization or extraction;

(h) optionally fixing the nanoparticles to each other and to the surface by thermal treatments; and

(i) optionally adding a bonded phase to functionalize the surface and charged nanoparticles,

where the polyelectrolyte has a molecular weight at the ionic strength of the fluid that is effective so that the first, second, and subsequent multilayers independently include a multiplicity of charged nanoparticle layers that are thicker than monolayers.

In some embodiments of the process, the fluid is water.

In a further embodiment of the process, the polyelectrolyte has a weight average molecular weight (M_{w}) of 100 kD or greater. In a still further embodiment of the process, the polyelectrolyte has a weight average molecular weight (M_{w}) of 250 kD or greater. In a still further embodiment of the process, the polyelectrolyte has a weight average molecular weight (M_{w}) of 350 kD or greater. In a still further embodiment of the process, the polyelectrolyte has a weight average molecular weight (M_{w}) of 500 kD or greater.

In another embodiment of the process, the ionic strength of the system is less than 0.05M.

In a still further embodiment of the process, the polyelectrolyte is selected from poly(diethylaminoethylmethacrylate) acetate (poly-DEAM), poly-p-methacrylyloxyethyldiethylmethyl ammonium methyl sulfate (poly-p-MEMAMS), poly(diallyldimethylammonium) chloride (PDADMA), and polymethacrylic acid.

The surface employed in the process can include core particles. In a desirable embodiment, the core particles can include silica or a silica/organic hybrid.

The charged nanoparticles employed in the process can include nanoparticles selected from silica, silica/organic hybrid, alumina, nanoclays, nanotubes, and the like.

In a further embodiment of the present invention, the nanoparticle-coated surface may be chemically modified with a bonded phase utilizing, without limitation, surface modifiers having the formula Zₐ(R⁵)_{b} Si—R, where Z is Cl, Br, I, C₁-C₅ alkoxy, or dialkylamino, a and b are each an integer from 0 to 3 provided that a+b=3, R⁵ is a C₁-C₆ straight, cyclic or branched alkyl group, and R is a functionalizing group.

In some embodiments, R⁵ can be selected from methyl, ethyl, propyl, isopropyl, butyl, t-butyl, sec-butyl, pentyl, isopentyl, hexyl, cyclohexyl and combinations thereof.

In some embodiments, R can be selected from alkyl, aryl, cyano, amino, diol, nitro, cation or anion exchange groups, embedded polar functionalities, and combinations thereof. More specifically, in some embodiments, R can be selected from C₁-C₂₀ alkyl, C₁-C₄-phenyl; cyanoalkyl, diol groups, aminopropyl, carbamate, and combinations thereof.

Some other embodiments provide a process for preparing a coated core including the steps of:

(a) providing a spherical silica core to be coated in a fluid;

(b) treating the spherical core with polyelectrolyte by exposing the core to a solution or suspension of polyelectrolyte to form a first-treated surface;

(c) removing excess non-bound polyelectrolyte without drying the first-treated surface;

(d) further treating the first-treated surface by attaching a first multilayer including a plurality of charged silica nanoparticles that are opposite in charge to the polyelectrolyte by exposing the product from step (c) to a suspension containing the charged nanoparticles;

(e) removing excess non-bound charged nanoparticles;

(f) repeating steps (b), (c), (d) and (e) by adding further layers of polyelectrolyte followed by multilayers of charged silica nanoparticles as many times as desired to produce a second and subsequent multilayers of charged silica nanoparticles on the core;

(g) removing the polyelectrolyte layers by volatilization or extraction;

(h) optionally fixing the silica nanoparticles to each other and to the core by thermal treatments; and

(i) optionally adding a bonded phase to functionalize the core and the charged silica nanoparticles,

wherein the polyelectrolyte has a weight average molecular weight of 100 kD or greater and the ionic strength of the fluid is less than 0.05M such that the first, second, and subsequent multilayers independently contain a multiplicity of charged silica nanoparticle layers that are thicker than monolayers.

In yet another embodiment, there is provided a chromatography column including a stationary phase, in which the stationary phase includes a surface prepared by the above-described process.

In a further embodiment of the invention, the chromatography column includes spherical non-porous silica particles of between 1 to 250 microns in diameter and the charged nanoparticles include silica nanoparticles having an average particle size in the range of about 4 to 1000 nm.

In yet another embodiment of the present invention, there is provided a spherical silica microparticle including a core and an outer porous shell surrounding the core. The microparticle is prepared by the above-described process. The microparticle has a diameter of about 1 μm to about 3.5 μm, a density of about 1.2 g/cc to about 1.9 g/cc and a surface area of about 50 m²/g to about 165 m²/g.

### BRIEF DESCRIPTION OF THE DRAWINGS

FIG. 1 shows a schematic diagram of the process for preparing a substrate with a porous surface in accordance with the present invention.

FIG. 2 shows particle diameter versus coating number data that was obtained with particles prepared in accordance with the present invention using low and medium molecular weight polyelectrolyte as the organic interlayers.

### DETAILED DESCRIPTION OF THE INVENTION

The present invention is directed to a process for coating a surface with particles, specifically nanoparticles. The surface can be of any shape, and the terms “core”, “core particles”, or “macroparticles”, as used herein, are synonymous with the term “surface” as it is used as the surface to be coated, and it is to be understood that the present invention refers to coating of any macrosurface including particulate matter.

As used herein, the term “colloidal particle” refers to inorganic particles or organic macromolecules or assemblies of organic molecules. The suspension of colloidal particles in a fluid, in particular water, is referred to herein as a “suspension”.

As used herein, the term “suspension” refers to any slurry, suspension or emulsion of particles of any shape or size in a fluid. Typically the fluid is water, although the present invention is not limited to aqueous suspensions. The suspension may refer to a system that is unstable with respect to settling over time but is dispersed for the period of use in the invention.

As used herein, the term “polyelectrolyte” refers to a charged organic colloid or charged macromolecule that is soluble or suspendable in the fluid.

As used herein, the term “nanoparticles” refers to particles with a largest dimension (e.g., a diameter) of less than, or less than or equal to about 1000 nm (nanometers). Also incorporated and included herein are all ranges of particle sizes that are between about 4 nm and about 1000 nm. The particle sizes of the coating nanoparticles will vary greatly depending on the nature of the nanoparticles and their eventual application.

As used herein, the term “monolayer” refers to a layer that is one particle thick, the layer thus being made up of substantially contiguous particles in a single plane. In contrast, the term “multilayer” refers to a multiplicity of layers. A multilayer is thus greater than one particle thick and made up of a plurality of particles in more than one plane.

As used herein, the term “impervious” does not require a material that is solid and impenetrable, but rather a material that will be undamaged by the process described herein for preparing the substrate with a porous surface.

In accordance with the process described herein, coating of one or more layers of nanoparticles onto a surface is accomplished by contacting the surface, desirably macroparticles (core particles), bearing a surface charge with a colloidal dispersion or a solution of a polyelectrolyte material which has an opposite charge. These polyelectrolyte molecules will be attracted to the oppositely-charged surface and become electrostatically bound thereto, forming a polyelectrolyte-coated surface or macroparticle. The surface with the attached polyelectrolyte will then assume an electrical charge that is now opposite to that which was on the surface originally. The reason for this is that once the colloidal particle binds to the macroparticle, the initial surface charges are neutralized so the coated area no longer appears oppositely charged to the polyelectrolyte molecules remaining in the dispersion. The surface will assume the charge of the polyelectrolyte and if the polyelectrolyte has a sufficiently high molecular weight and is in an extended form, then the surface charge attributable to the polyelectrolyte will extend beyond the immediate vicinity of the surface of the original core particle and the bound layer of polyelectrolyte. For instance, in some embodiments, the polyelectrolyte has a weight average molecular weight (M_{w}) of about 100 kiloDaltons (kD) or greater, specifically about 250 kD or greater, more specifically about 350 kD or greater and even more specifically about 500 kD or greater. However, lower molecular weight polyelectrolytes may be employed in some embodiments.

The core particle with the bound polyelectrolyte is not dried down to a state where the organic layer is held close to the surface of the core particle. Rather, the electrostatically bound layer of polyelectrolyte should be maintained in a solvated condition so that polyelectrolyte molecules extend out from the surface of the core particles. The extension of charge away from the surface allows the bound polyelectrolyte to achieve a higher capacity for attaching subsequent multilayers of oppositely charged nanoparticles than if the charge were restricted to the immediate vicinity of the surface.

Once the polyelectrolyte is bound to the surface, no further polyelectrolyte will be attracted to the surface, and there will be no further build-up of polyelectrolyte on the surface. Excess polyelectrolyte is then removed by rinsing, and the coated macroparticle is then immersed in a colloidal dispersion of nanoparticles of charge opposite from those of the organic polyelectrolyte. Repeating the process by alternating immersions between the polyelectrolyte and the colloidal inorganic nanoparticle results in the formation of further multilayers in sequence. The combination of sufficiently high molecular weight of polyelectrolyte and sufficiently low ionic strength in the reaction solution ensures that the layer of nanoparticles that is bound to the polyelectrolyte layer is not merely a monolayer but multiple layers of nanoparticles are bound in each layering step.

One of the layers, called the organic interlayer, will consist of colloidal organic particles, micelles of an organic material, or polyelectrolyte molecules. After a sequential coating of the desired number of layers of nanoparticles is built up, the interpolated organic interlayer(s) can be removed, desirably volatilized by heating or extracted with a solvent, leaving a series of layers of like nanoparticles, each nanoparticle being like the ones in each particular layer and also, but not necessarily, like those in adjacent layers. The nanoparticles in alternate layers can be of different size, shape or chemical composition to each other.

### The Surface

Any impervious material may be used as the surface to be coated. By impervious material, as defined above, it is not meant a material that is solid and impenetrable, but rather a material that will be undamaged by the process described herein for producing a porous coating on the material. The shape of the surface is not critical, although for chromatography, regularly shaped spherical macroparticles will be desirable because of their uniformity of packing characteristics. Any macroparticle shapes may be employed for other applications. These shapes may include rings, polyhedra, saddles, platelets, fibers, plates, wafers, hollow tubes, rods and cylinders. Spheres are desirable for chromatography because of their regular and reproducible packing characteristics and ease and convenience of handling. Other shapes of cores would be suitable for applications other than chromatography.

The composition of the core, macroparticle, or surface is not critical except that it should be stable to the conditions necessary to prepare the coating. The macroparticles could be, for example, glasses, sands, ceramics, metals or oxides. In addition to impervious cores such as these, other types such as aluminosilicate molecular sieve crystals or porous chromatography supports could be used.

In general, materials that have some structural rigidity will be desirable. As pointed out, the macroparticle should be capable of acquiring an electrical charge in the presence of the dispersion medium as this provides the attractive force enabling it to adsorb a first layer of the coating material. Many water wettable inorganic substrates, such as silica, have negatively charged surfaces.

Nonporous high purity silica particles are particularly suitable macroparticles or cores for chromatography applications of this invention because of their uniformity of surface characteristics and predictability of packing.

The cores, macroparticles or surface, as well as the nanoparticles for coating the cores, can also be “hybrid”, which includes inorganic-based structures in which an organic functionality is integral to both the internal or “skeletal” inorganic structure as well as the hybrid material surface. The inorganic portion of the hybrid material may be, for example, alumina, silica, titanium or zirconium oxides, or ceramic material; in a particularly desirable embodiment, the inorganic portion is silica. Exemplary hybrid materials are shown in U.S. Pat. Nos. 4,017,528 and 6,528,167, the contents of which are incorporated herein by reference in their entirety. For example, in one embodiment in which the inorganic portion is silica, “hybrid silica” refers to a material having the formula SiO₂/(R¹ₚR²_{q} SiOₜ)ₙ or SiO₂/[R³ (R¹ᵣSiOₜ)ₘ]ₙ; wherein R¹ and R² are independently a substituted or unsubstituted C₁ to C₇ alkyl group, or a substituted or unsubstituted aryl group, R³ is a substituted or unsubstituted C₁ to C₇ alkylene, alkenylene, alkynylene, or arylene group bridging two or more silicon atoms, p and q are 0, 1, or 2, provided that p+q=1 or 2, and that when p+q=1, t=1.5, and when p+q=2, t=1; r is 0 or 1, provided that when r=0, t=1.5, and when r=1, t=1; m is an integer greater than or equal to 2; and n is a number from 0.01 to 100.

The size of the cores or macroparticles will, in general, not be critical. For spheres and similarly shaped bodies, a size in the range of an average diameter of from 0.1-500 microns prior to coating will be desirable for chromatography.

### The Coating

The charged nanoparticles with which the surface is to be coated are held in a suspension in a fluid. The nanoparticles may be inorganic or organic or a mixture of both.

The coating of the finished product to be used as a chromatographic separative material desirably consists of multilayers of like inorganic nanoparticles. Such nanoparticles are alike in charge and desirably, but not necessarily, in chemical composition. For example, the nanoparticle may be a mixture of colloidal nanoparticles of silica and of colloidal nanoparticles of titanium dioxide coated previously with a thin layer of silica. There is no substantial limitation as to the nature or composition of these nanoparticles except their suitability for use in the desired application. They will be chosen in the light of the eventual applications envisioned with respect to, for example, the nature of the chromatographically active substance, if any, which may be employed in conjunction with them or coated on their surfaces, and the materials which will be chromatographically separated with respect to chemical type, size of molecules, and the like.

The particle sizes of the coating nanoparticles will vary greatly depending on the nature of the nanoparticles and their eventual application. Broadly, particle sizes in the range of from about 4 to 1000 nanometers may be employed, but the invention is not limited to such ranges.

The coating nanoparticles may be any desired substances that can be reduced to a colloidal state of subdivision in which the nanoparticles have surfaces bearing ionic charges. They should be dispersible in a medium as a colloidal dispersion. Water is a particularly suitable medium for dispersions of particles bearing ionic charges. Examples of aqueous dispersions of colloidal nanoparticles, sometimes called sols, are dispersions of colloidal amorphous silica, iron oxide, alumina, thoria, titania, zirconia, and aluminosilicates including colloidal clays, such as montmorillonite, colloidal kaolin, attapulgite, and hectorite. Silica is a particularly desirable material because of its low order of chemical activity, its ready dispersibility, and the easy availability of aqueous sols of various concentrations. The coating nanoparticles can also include organic materials and biological materials such as proteins, enzymes, antibodies, DNA or RNA as a suspension or solution in the fluid.

In some embodiments, the surface of the coated nanoparticles to be used in chromatographic columns may be further modified by various treatments, such as reaction with silanes, alcohols or metal oxides, depending on the type of chromatographic separation which is required. The surface of the coating particles may also be modified by treatment with bioactive materials, for example proteins, enzymes, antibodies, DNA, and RNA to provide a bioactive surface on the particles.

By “nanoparticles”, as defined above, it is meant particles with a largest dimension (e.g., a diameter) of less than, or less than or equal to about 1000 nm, more specifically about 4 nm to about 1000 nm. Such particles are technologically significant as they are utilized to fabricate structures, coatings, and devices that have novel and useful properties due to the very small dimensions of their particulate constituents. Nanoparticles with particle sizes ranging from about 4 nm to about 1000 nm can be economically produced. Non-limiting examples of particle size distributions of the nanoparticles are those that fall within the range from about 4 nm to less than about 1000 nm, alternatively from about 4 nm to less than about 200 nm, and alternatively from about 4 nm to less than about 150 nm. It should also be understood that certain ranges of particle sizes may be useful to provide certain benefits, and other ranges of particle sizes may be useful to provide other benefits. The mean particle size of various types of particles differs from the particle size distribution of the particles. For example, a layered synthetic silicate can have a mean particle size of about 25 nanometers whereas its particle size distribution can generally vary between about 10 nm to about 40 nm. It should be understood that the particle sizes that are described herein are for particles when they are dispersed in an aqueous medium and the mean particle size is based on the mean of the particle number distribution.

Non-limiting examples of nanoparticles include crystalline or amorphous particles with a particle size from about 4 nm to about 1000 nm. Boehmite alumina can have an average particle size distribution from 4 nm to 1000 nm.

Nanotubes are also examples of particles that can be used as nanoparticles in the process of the present invention and include a particle diameter of from about 4 nm to about 500 nm.

Some layered clay minerals and inorganic metal oxides also are examples of nanoparticles, and are also referred to herein as “nanoclays”. Without intending to limit the scope of the claims contained herein, the layered clay minerals suitable for use in some embodiments of the present invention include those in the geological classes of the smectites, the kaolins, the illites, the chlorites, the attapulgites and the mixed layer clays. Typical examples of specific clays belonging to these classes are the smectices, kaolins, illites, chlorites, attapulgites and mixed layer clays. Smectites, for example, include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. Illites include bravaisite, muscovite, paragonite, phlogopite and biotite. Chlorites include corrensite, penninite, donbassite, sudoite, pennine and clinochlore. Attapulgites include sepiolite and polygorskyte. Mixed layer clays include allevardite and vermiculitebiotite. Variants and isomorphic substitutions of these layered clay minerals offer unique applications.

Before elimination of the organic interlayer, the colloidal nanoparticles in any particular multilayer are like each other but may be different from the nanoparticles in an adjacent multilayer. The alikeness of nanoparticles in each multilayer has reference mainly to their surface characteristics and especially their surface electrical charge. Ordinarily they would be alike in chemical composition and similar in size and shape. In a desirable aspect, this size and shape will be substantially uniform.

The nanoparticles for coating may also be “hybrid”, for example, as in “porous inorganic/organic hybrid particles” as described above.

A “bonded phase” may be formed onto the nanoparticle coating or the macroparticle cores by adding functional groups to their surfaces. Examples of a process for the formation of bonded phases can be found in, for example, Lork, K. D., et. al., J. Chromatogr., 352 (1986) 199-211, incorporated herein by reference in its entirety. For example, without intending to limit the scope of the claims contained herein, the surface of silica contains silanol groups, which can be reacted with a reactive organosilane to form a “bonded phase”. Bonding involves the reaction of silanol groups at the surface of the silica particles with, for example, halo or alkoxy substituted silanes, thus producing a Si—O—Si—C linkage.

Silanes for producing bonded silica include, in decreasing order of reactivity: RSiX₃, R₂SiX₂, and R₃SiX, where X is dialkyl amino, such as dimethylamino, halo, such as chloro, alkoxy, or other reactive groups. Some illustrative silanes for producing bonded silica, in order of decreasing reactivity, include n-octyldimethyl(dimethylamino)silane, n-octyldimethyl(trifluoroacetoxy)silane, n-octyldimethylchlorosilane, n-octyldimethylmethoxysilane, n-octyldimethylethoxysilane, and bis-(n-octyldimethylsiloxane). The monochlorosilane is the least expensive and most commonly used silane.

Other illustrative monochlorosilanes that can be used in producing bonded silica include: Cl—Si(CH₃)₂—(CH₂)ₙ—X, where X is H, CN, fluorine, chlorine, bromine, iodine, phenyl, cyclohexyl, dimethylamine, or vinyl, and n is 1 to 30 (desirably 2 to 20, more desirably 3 to 18); Cl—Si(CH₃)₂—(CH₂)₈—H (n-octyldimethylsilyl); Cl—Si(CH(CH₃)₂)₂—(CH₂)ₙ—X, where X is H, CN, fluorine, chlorine, bromine, iodine, phenyl, cyclohexyl, dimethylamine, or vinyl; and Cl—Si(CH(Phenyl)₂)₂—(CH₂)ₙ—X where X is H, CN, fluorine, chlorine, bromine, iodine, phenyl, cyclohexyl, dimethylamine, or vinyl.

For chromatographic particles the surface derivatization is conducted according to standard methods, for example by reaction with n-octyldimethylchlorosilane in an organic solvent under reflux conditions. An organic solvent such as toluene is typically used for this reaction. An organic base such as pyridine or imidazole is added to the reaction mixture to accept hydrochloric acid produced from the reaction with silanol groups and thus drive the reaction towards the desired end product. The thus-obtained product typically is then washed with toluene, water and acetone and dried at 100° C. under reduced pressure for example for 16 hours.

The terms “functionalizing group” and “functional group” typically include organic functional groups that impart a certain chromatographic functionality to a chromatographic stationary phase, including, for example, octadecyl (C₁₈), phenyl, ligands with ion exchange groups, and the like. Such functionalizing groups are present in, for example, surface modifiers such as disclosed herein, which are attached to the base material, for example, via derivatization or coating and later crosslinking, imparting the chemical character of the surface modifier to the base material. In an illustrative embodiment, such surface modifiers have the formula Zₐ(R⁵)_{b} Si—R, where Z=Cl, Br, I, C₁-C₅ alkoxy, dialkylamino, such as, dimethylamino, or trifluoromethanesulfonate; a and b are each an integer from 0 to 3 provided that a+b=3; R⁵ is a C₁-C₆ straight, cyclic or branched alkyl group, and R is a functionalizing group. R⁵ may be, but not limited to, methyl, ethyl, propyl, isopropyl, butyl, t-butyl, sec-butyl, pentyl, isopentyl, hexyl or cyclohexyl.

The functionalizing group R may include alkyl, aryl, cyano, amino, diol, nitro, cation or anion exchange groups, or embedded polar functionalities. Examples of suitable R functionalizing groups include C₁-C₂₀ alkyl such as octyl (C₈) and octadecyl (C₁₈); alkaryl, for example, C₁-C₄-phenyl; cyanoalkyl groups, for example, cyanopropyl; diol groups, for example, propyldiol; amino groups, for example, aminopropyl; and embedded polar functionalities, for example, carbamate functionalities such as disclosed in U.S. Pat. No. 5,374,755. In a desirable embodiment, the surface modifier may be a haloorganosilane, such as octyldimethylchlorosilane or octadecyldimethylchlorosilane. Embedded polar functionalities include carbamate functionalities such as disclosed in U.S. Pat. No. 5,374,755. In another embodiment, the macroparticles may be surface modified by polymer coating. This polymeric coating can be chemically bonded or mechanically held to the macroparticle surface.

In some embodiments, the chromatographic stationary phase may be endcapped. A chromatographic stationary phase is said to be “endcapped” when a small silylating agent, such as trimethylchlorosilane, is used to react residual silanol groups on a packing surface after initial silanization. Endcapping is most often used with reversed-phase packings and may reduce undesirable adsorption of basic or ionic compounds. For example, endcapping occurs when bonded hybrid silica is further reacted with a short-chain silane such as trimethylchlorosilane to endcap the remaining silanol groups. The goal of endcapping is to remove as many residual silanols as possible. In order of decreasing reactivity, illustrative agents that may be used as trimethylsilyl donors for end capping include trimethylsilylimidazole (TMSIM), bis-N,O-trimethylsilyltrifluoroacetamide (BSTFA), bis-N,O-trimethylsilylacetamide (BSA), trimethylsilyldimethylamine (TMSDMA), trimethylchlorosilane (TMS), and hexamethyldisilane (HMDS). Preferred endcapping reagents include trimethylchlorosilane (TMS), trimethylchlorosilane (TMS) with pyridine, hexamethyldisilazane (HMDS), and trimethylsilylimidazole (TMSIM).

### The Organic Interlayers

As previously discussed, the coating procedure includes the insertion of alternate multilayers of colloidal organic particles or organic polyelectrolyte molecules of opposite charge between the layers of coating nanoparticles as an important part of the sequential coating process. The interpolated layers provide the fresh, oppositely charged surfaces needed for the attraction and holding of the coating nanoparticles.

The composition of the organic polyelectrolyte interlayers is not critical, however, the average molecular weight (weight average, M_{w}) has been shown to have an effect on the number of multilayers of nanoparticles that are laid down per coating/wash cycle. Organic interlayers, for example, negatively or positively charged water-soluble gums, natural lattices, artificial lattices, proteins, synthetic polymers, and synthetic condensation products may be employed if suitably dispersible. The M_{w} of the desired organic interlayer is sufficient to provide a surface to which coating nanoparticles can bind in a layer thickness that is greater than one monolayer. To ensure this layer thickness, the organic interlayer should not be dried down during the coating process, as drying will tend to drive the polyelectrolyte to the core surface, rather than leave it to extend from the surface so that it can bind multiple nanoparticles per layer. The thickness of the coating layer will also depend on the ionic strength of the medium and in some embodiments, no additional salt is added to the medium. However, for purposes of control of the process, salt may be added as needed to produce the desired layer thickness.

Without wishing to be constrained by mechanism, it is believed that the thickness of each coating cycle is affected by ionic strength as a result of the shielding of charges along the chain of the polyelectrolyte by ions in solution. The end to end distance of the chain, and hence the area of chain exposed to nanoparticles, is governed by the Debye length of the system, which is a function of ionic strength. A detailed discussion of this phenomenon appears, for example, in “The Theory of Polyelectrolyte Solutions” by J-L. Barrat and J-F. Joanny, Advances in Chemical Physics 54 (1996) 1 and in X. Chatelier and J-F. Joanny, J. Phys II (France) 6 (1996) 1669-1686. One skilled in the art would be able to determine the optimum conditions of M_{w} of the polyelectrolyte and ionic strength of the solution for a required application.

As mentioned above, typical values of M_{w} suitable for the polyelectrolyte are about 100 kiloDaltons (kD) or greater, specifically about 250 kD or greater, more specifically about 350 kD or greater and even more specifically about 500 kD or greater. However, lower molecular weight polyelectrolytes may be employed in some embodiments. Organic surfactants which form micelles in aqueous solution, may be employed since the micelles act as colloidal particles. The ionic strength of the solution may be less than about 0.05 M of salt, and more specifically less than about 0.02 M of salt.

Specific materials will be chosen with respect to the nature of the inorganic coating to provide the necessary opposite charge. Without intending to limit the scope of the claims contained herein, examples of suitable polyelectrolyte materials include poly(diethylaminoethylmethacrylate) acetate (poly-DEAM) or poly-p-methacrylyloxyethyldiethylmethyl ammonium methyl sulfate (poly-p-MEMAMS), poly(diallyldimethylammonium) chloride (PDADMA), and polymethacrylic acid.

### Depositing the Coating

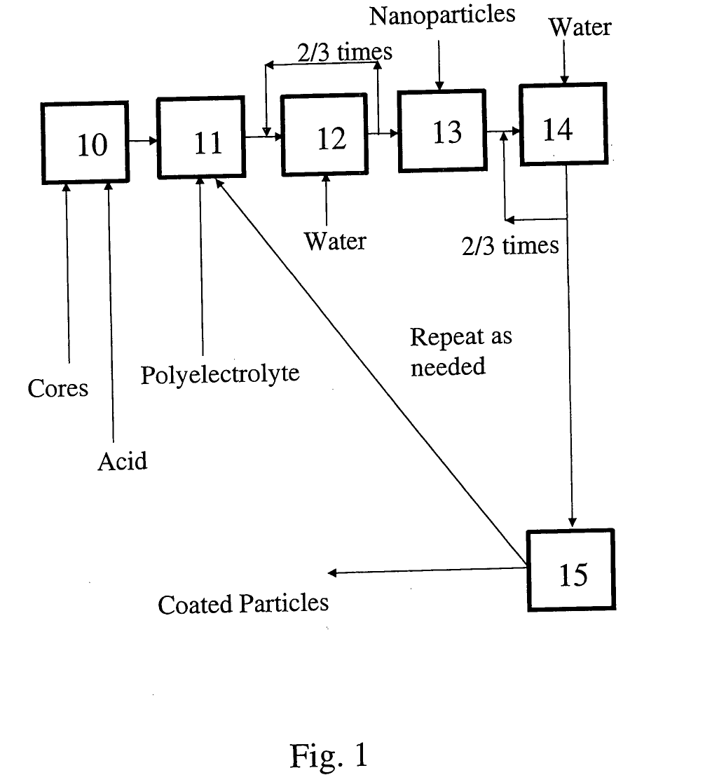

In accordance with some embodiments, FIG. 1 depicts a schematic diagram of a process of the present invention. As shown in FIG. 1, the cleaned surface or particulate cores are immersed in a fluid dispersion and optionally brought to a pH of less than approximately 7 with acid in an acidification step (10). Any suitable acid can be employed and nitric acid is particularly desirable. The first coating can be the organic (polyelectrolyte) or the charged nanoparticles depending on the electrical charges of the colloids. Typically, the polyelectrolyte will be first applied as a binder or interlayer between the macroparticle core surface and the coating nanoparticles, as shown in step 11 in the FIG. 1. After depositing a monolayer of the polyelectrolyte, the surface is rinsed (step 12) with a liquid, which will rinse off any excess polyelectrolyte not directly bound to the surface. Water is commonly employed as a fluid, and the rinse is carried out as many times as desired to remove the composition of excess polyelectrolyte. Two to three rinse cycles are typical as shown in the FIG. 1. The treated, rinsed surface is then immersed in a dispersion of the coating nanoparticles (step 13), which are to form the permanent coating. The pH of the dispersion is typically less than 7, and desirably approximately 2.0-6.0.

The double-coated surface is now rinsed again (step 14) and optionally filtered or centrifuged to harvest the treated surface 15 from the fluids. The process of deposition of polyelectrolyte and coating nanoparticles through sequential processing is repeated until the desired number of multilayers of nanoparticles are put down on the surface. When the desired thickness has been built up, the nanoparticle coatings may be made permanent, typically by heating. Heating may be done at a high enough temperature so as to decompose, volatilize, or oxidize the organic interlayer, or alternatively, the particles may just be dried and the organic interlayer removed by chemical means such as by oxidation or solvent extraction. However, for most chromatographic applications, the organic (polyelectrolyte) interlayers would be substantially removed by volatilization which usually will involve thermal decomposition or oxidation.

The foregoing is a brief sketch of the coating process. It will be understood by one skilled in the art that minor variations are possible and these are intended to be covered by the scope of the claims described herein.

Prior to use in gas chromatography, it will sometimes be considered desirable to modify or establish the chromatographic properties of superficially porous chromatographic supports formed when the surface is a core particle by treating them with a sorptively active liquid phase. Typical examples of commonly employed sorbents in gas chromatography are polyethylene glycol, squalane, silicone oil, and others. This coating procedure and the subsequent preparation of suitable chromatographic columns will then be carried out using methods also well known to the art, as shown, for example in, S. Dal Nogare, R. S. Juvet Jr., “Gas-Liquid Chromatography”, Interscience Publishers, New York (1962).

Substrate with Porous Surface Product

The finished product is a substrate with a porous surface. This product may be used in a variety of different applications. In some embodiments, for instance, the product is ready to be used as a stationary phase in the preparation of chromatographic apparatus, especially columns, including superficially porous refractory particles. In general, where the core material is in the shape of spheres or similar shapes, the total diameter of the particles will be from 1-500 microns overall. The coating on such a shaped particle is a series of layers of nanoparticles and represents, in general, from about 0.5% to about 75% by volume of the total volume of the coated macroparticles.

In some desirable embodiments of the present invention, spherical high purity non-porous silica macroparticles of about 1-250 microns in diameter may be coated with silica nanoparticles having an average particle size of about 4 nm to about 1000 nm. The organic interlayers may be, for example, polyBEAM, poly-p-MEMAMS, or PDADMA and will be removed by heating, leaving a superficially porous coating.

In some particularly desirable embodiments, the product may be a microparticle for use in liquid chromatographic columns, particularly spherical silica microparticles, such as described in commonly assigned U.S. patent application entitled “Porous Microparticles with Solid Cores” and filed on Feb. 13, 2007 (Express Mail Label No. EV 974903651 US, Attorney Docket No. 1644-7), the contents of which are incorporated herein by reference in their entirety. As described therein, the silica microparticles may have a solid core and porous shell formed by the multi-multilayering process of the present invention. The core may formed from a high purity non-porous silica and the porous shell may be formed from silica nanoparticles. Microparticles formed by this process may have a smaller particle diameter, as well as a greater density and surface area than conventional totally porous particles.

Specifically, in some embodiments, the microparticles may have a diameter of about 1 μm to about 3.5 μm. The particles may have a density of about 1.2 g/cc to about 1.9 g/cc, more specifically about 1.3 g/cc to about 1.6 g/cc, and a surface area of about 50 m²/g to about 165 m²/g. The porous outer shell may have a thicknesses of 0.1 μm to 0.75 μm. Additionally, the outer shells formed from the nanoparticles may have an average pore size of 4 nm to 175 nm resulting from the random open-packed nanoparticle configuration. More specifically, the porous outer shell desirably is formed using colloidal nanoparticles in a manner to produce a largely random pore structure with a relatively broad pore size distribution. In particular, the pore size distribution of the outer porous shell is about 40% to about 50% (one sigma) of the average pore size with a porosity of about 55% to about 65% by volume of the outer porous shell. The porosity is about 25% to about 90% by volume of the total microparticle.

Further, the resulting microparticles may have an extremely narrow and uniform size distribution, which is less than +15% (one sigma) of the volume average diameter, more specifically less than ±10% (one sigma) of the volume average diameter, and even more specifically about ±5% (one sigma) of the volume average diameter in some embodiments.

In a further embodiment, the coated macroparticles may be sintered and rehydroxylated. An example of sintering and rehydroxylation is disclosed in U.S. Pat. No. 4,874,518, incorporated herein in its entirety by reference.

### EXAMPLES

In the following examples, particle size was measured using a Beckman Coulter Multisizer 3 instrument (Beckman Instruments, California) as follows. Particles are suspended homogeneously in Isoton II (Beckman Instruments, CA, 8546719). A greater than 30,000 particle count may be run using a 20 μm aperture in the volume mode for each sample. Using the Coulter principle, volumes of particles are converted to diameter, where a particle diameter is the equivalent spherical diameter, which is the diameter of a sphere whose volume is identical to that of the particle.

### Example 1

A 10% by weight aqueous suspension of silica core particles comprising 5 g of SiO₂ particles of diameter 2.0 μm was brought to a pH of 2.3 with nitric acid. To these cores was added 200 grams of 0.5% by weight of aqueous solution of poly(diallyldimethylammonium) chloride (PDADMA). This solution was made by diluting 20% by weight aqueous solutions of polyelectrolyte (Sigma-Aldrich, 409014, 409022, and 409030—“Low”, “Medium”, and “High” weight average molecular weights of PDADMA were used, corresponding to M, values of 100-200 kD, 200-350 kD, and 400-500 kD according to the manufacturer). The polyelectrolyte and silica core suspension was centrifuged at 2,000 rpms for 10 minutes (using a Sorvall T6000 model centrifuge) and the supernatant was decanted. The cores were resuspended in deionized water, centrifuged (about 2,000 rpms for 10 minutes) and the supernatant was decanted. This wash with deionized water was repeated one additional time. 50 grams of an aqueous suspension of silica nanoparticles (9.88% SiO₂ by weight) of diameter 8 nanometers (nm), adjusted to pH 3.5 with nitric acid, were added to the polyelectrolyte-coated cores and mixed for 10 minutes with a stir bar. The solution of cores and nanoparticles was then centrifuged (about 2,000 rpms for 10 minutes) and the supernatant containing excess nanoparticles in suspension was decanted. The nanoparticle-coated core material was resuspended in deionized water and the particle size of the nanoparticle-coated product was then measured by Coulter Counter. The number of layers of particles per coating was estimated from the increase in particle diameter.

Table 1 shows the number of layers of nanoparticles per coating (N) as a function of M_{w} of the polyelectrolyte.

TABLE 1

| Mw of Polyelectrolyte (kD) | N |
|---|---|
| 100-200 | 5 |
| 200-350 | 15 |
| 400-500 | 15 |

### Example 2

A 10% by weight aqueous suspension of silica core particles including 5 g of SiO₂ of diameter 2.0 μm was brought to a pH of 2.3 with nitric acid. To these cores was added 200 grams of 0.5% by weight of aqueous solution of poly(diallyldimethylammonium) chloride (PDADMA). This solution was made by diluting 20% by weight aqueous solutions of polyelectrolyte (Sigma-Aldrich, 409014 and 409022—“Low” and “Medium” weight average molecular weights of PDADMA were used, corresponding to M_{w} values of 100-200 kD and 200-350 kD according to the manufacturer.) The polyelectrolyte and silica core suspension was centrifuged at 2,000 rpms for 10 minutes and the supernatant was decanted. The cores were resuspended in deionized water, centrifuged (about 2,000 rpms for 10 minutes) and the supernatant was decanted. This wash with deionized water was repeated two additional times. 15 grams of an aqueous suspension of silica nanoparticles (7.62% SiO₂ by weight) of diameter 8 nanometers (nm), adjusted to pH 3.5 with nitric acid, were added to the polyelectrolyte-coated cores and mixed for 10 minutes with a stir bar. The solution of cores and nanoparticles was then centrifuged (about 2,000 rpms for 10 minutes) and the supernatant containing excess nanoparticles in suspension was decanted. The nanoparticle-coated core material was resuspended in deionized water and the particle size of the nanoparticle-coated product was then measured by Coulter Counter. The process was then repeated to apply multiple coats of multiple nanoparticles.

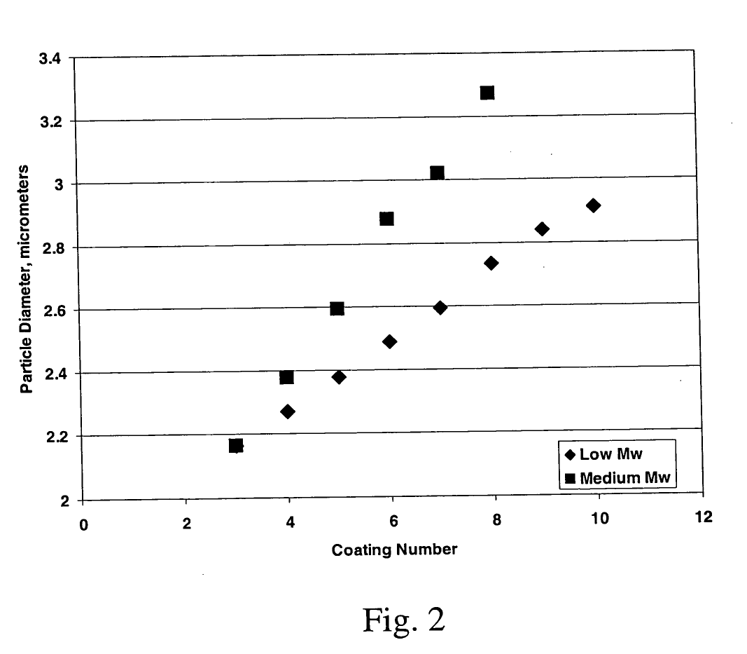

FIG. 2 shows particle diameter as a function of coating number that was obtained for the low (100-200 kD) and medium (200-350 kD) molecular weight PDADMA. The effect of using the higher molecular weight polyelectrolyte is clearly shown.

What is claimed is:

1. A process for preparing a coated surface comprising the steps of:
(a) providing a surface to be coated in a fluid;
(b) treating said surface with polyelectrolyte by exposing said surface to a solution or suspension of polyelectrolyte to form a first-treated surface;
(c) removing excess non-bound polyelectrolyte without drying said first-treated surface;
(d) further treating said first-treated surface by attaching a first multilayer comprising a plurality of charged nanoparticles that are opposite in charge to said polyelectrolyte by exposing said product from step (c) toga suspension comprising said charged nanoparticles;
(e) removing excess non-bound charged nanoparticles;
(f) optionally repeating steps (b), (c), (d) and (e) by adding further layers of polyelectrolyte followed by multilayers of charged nanoparticles as many times as desired to produce a second and subsequent multilayers of charged nanoparticles on said surface;
(g) optionally removing said polyelectrolyte layers by volatilization or extraction;
(h) optionally fixing said nanoparticles to each other and to said surface by thermal treatments; and
(i) optionally adding a bonded phase to functionalize said surface and said charged nanoparticles,
wherein said polyelectrolyte has a molecular weight at the ionic strength of the fluid that is effective so that said first, second, and subsequent multilayers, independently comprise a multiplicity of charged nanoparticle layers that are thicker than monolayers.

2. The process of claim 1, wherein said fluid is water.

3. The process of claim 1, wherein said polyelectrolyte has a weight average molecular weight (M_{w}) of 100 kD or greater.

4. The process of claim 1, wherein said polyelectrolyte has a weight average molecular weight (M_{w}) of 250% or greater.

5. The process of claim 1, wherein said polyelectrolyte has a weight average molecular weight (M_{w}) of 350 kD or greater.

6. The process of claim 1, wherein said polyelectrolyte has a weight average molecular weight (M_{w}) of 500 kD or greater.

7. The process of claim 2, wherein the ionic strength of the fluid is less than 0.05M.

8. The process of claim 2, wherein the ionic strength of the fluid is less than 0.02M.

9. The process of claim 1, wherein said polyelectrolyte is selected from the group consisting of poly(diethylaminoethylmethacrylate) acetate (poly-DEAM), poly-p-methacrylyloxyethyldiethylmethyl ammonium methyl sulfate (poly-p-MEMAMS), poly(diallyldimethylammonium) chloride (PDADMA), and polymethacrylic acid.

10. The process of claim 1, wherein said surface comprises a core particle.

11. The process of claim 10, wherein said core particle is selected from the group consisting of a silica core particle and a silica/organic hybrid core particle.

12. The process of claim 1, wherein said charged nanoparticles comprise particles selected from the group consisting of silica, silica/organic hybrid, alumina, nanoclays and nanotubes.

13. The process of claim 1, wherein said bonded phase comprises surface modifiers having the formula Zₐ(R⁵)_{b} Si—R, wherein Z is Cl, Br, I, C₁-C₅ alkoxy, or dialkylamino, a and b are each an integer from 0 to 3 provided that a+b=3, R⁵ is a C₁-C₆ straight, cyclic or branched alkyl group, and R is a functionalizing group.

14. The process of claim 13, wherein R⁵ is selected from the group consisting of methyl, ethyl, propyl, isopropyl, butyl, t-butyl, sec-butyl, pentyl, isopentyl, hexyl, cyclohexyl and combinations thereof.

15. The process of claim 13, wherein R is selected from the group consisting of alkyl, aryl, cyano, amino, diol, nitro, cation or anion exchange groups, embedded polar functionalities, and combinations thereof.

16. The process of claim 13, wherein R is selected from the group consisting of C₁-C₂₀ alkyl, C₁-C₄-phenyl; cyanoalkyl, diol groups, aminopropyl, carbamate, and combinations thereof.

17. A process for preparing a coated core comprising the steps of:
(a) providing a spherical silica core to be coated in a fluid;
(b) treating said spherical core with polyelectrolyte by exposing said core to a solution or suspension of polyelectrolyte to form a first-treated surface;
(c) removing excess non-bound polyelectrolyte without drying said first-treated surface;
(d) further treating said first-treated surface by attaching a first multilayer comprising a plurality of charged silica nanoparticles that are opposite in charge to said polyelectrolyte by exposing said product from step (c) to a suspension comprising said charged nanoparticles;
(e) removing excess non-bound charged nanoparticles;
(f) repeating steps (b), (c), (d) and (e) by adding further layers of polyelectrolyte followed by multilayers of charged silica nanoparticles as many times as desired to produce a second and subsequent multilayers of charged silica nanoparticles on said core;
(g) removing said polyelectrolyte layers by volatilization or extraction;
(h) optionally fixing said silica nanoparticles to each other and to said core by thermal treatments; and
(i) optionally adding a bonded phase to functionalize said core and said charged silica nanoparticles,
wherein said polyelectrolyte has a weight average molecular weight of 100 kD or greater and the ionic strength of the fluid is less than 0.05M such that said first, second, and subsequent multilayers independently comprise a multiplicity of charged silica nanoparticle layers that are thicker than monolayers.

18. A chromatography column comprising a stationary phase, said stationary phase comprising a surface prepared by the process of claim 1.

19. The chromatography column of claim 18, wherein said surface comprises spherical non-porous silica particles of between 1 to 250 microns in diameter and said charged nanoparticles comprise silica nanoparticles having an average particle size in the range of about 4 nm to about 1000 nm.

20. A spherical silica microparticle comprising a core and an outer porous shell surrounding said core, said microparticle prepared by the process of claim 1,
wherein said microparticle has a diameter of about 1 μm to about 3.5 μm, a density of about 1.2 g/cc to about 1.9 g/cc and a surface area of about 50 m²/g to about 165 m²/g.
